(19) United States
(12) Patent Application Publication
(10) Pub. No.: US 2002/0127918 A1
(43) Pub. Date: Sep. 12, 2002

(54) AC-adapter and pin configuration adapter for AC-adapter

(76) Inventors: Terutomo Kajiwara, Iizuka-Shi (JP); Takenori Kinkawa, Iizuka-Shi (JP); Hidetoshi Hamai, Iizuka-Shi (JP)

Correspondence Address: LADAS & PARRY, 224 SOUTH MICHIGAN AVENUE, SUITE 1200, CHICAGO, IL, 60604, US

(21) Appl. No.: 10/078,762

(22) Filed: Feb. 19, 2002

(30) Foreign Application Priority Data
Mar. 2, 2001 (JP) 2001-059274

(51) Int. Cl. H01R 25/00

(52) U.S. Cl. 439/651

(57) ABSTRACT

A combination includes an AC-adapter and a pin configuration adapter. The AC-adapter includes a plug body having first pins of a first configuration and an AC-adapter housing having a conversion circuit for converting an electric power supplied via the plug body. The pin configuration adapter includes a plug part having second pins of a having configuration different from the first pin configuration, a receptacle part whereto the first pins can be inserted and a pin configuration adapter housing having an internal connection mechanism for electrically connecting the plug body and the plug part. The AC-adapter is provided with engagement grooves which engage with protrusions provided on said pin configuration adapter.

### BACKGROUND OF THE INVENTION

1. Field of the Invention

The present invention relates to a pin configuration adapter for an AC-adapter, and particularly relates to a pin configuration adapter having a different pin type from that of the AC-adapter and which is, in use, attached to the AC-adapter.

2. Description of the Related Art

Generally, a power transformer (AC-adapter) is widely used for supplying power to portable electronic devices and/or for recharging batteries of such electronic devices. The power transformer includes a housing, a plug protruding from the housing, a conversion circuit provided inside the housing and an output cord extending from the housing. In order to plug the power adapter to the power socket, the pins are inserted into the power socket. In the converting circuit, an alternating current supplied from the power socket is converted to a direct current of a predetermined voltage. The obtained direct current is output from the output cord which may be connected to an electronic device.

Recently, many people bring such devices abroad on their private or business trips. However, there is no global standard configuration for a power socket, and therefore there are various configuration of the power socket for various countries.

Accordingly, an AC-adapter having a parallel-blade pin configuration conforming to a standard adopted in countries such as Japan, Taiwan and the US, cannot be used in those countries where power sockets are configured to match a pin configuration different from the parallel-blade type. Therefore, the traveller wishing to travel in such a country had to purchase and bring AC-adapters conforming to pin configurations adopted in the country or countries he wishes to travel in.

However, it is troublesome to prepare AC-adapters of different pin configurations conforming to the domestic standard and to foreign standards. Also, since each of the AC-adapters has a conversion circuit therein, it is comparatively expensive to prepare different types of AC-adaptors. Therefore, it is an economic burden for a user of a portable electronic device to prepare expensive AC-adapters for each standard with different pin configuration.

In order to overcome the above-mentioned problem, it is known to provide pin configuration adapters having pin configurations different from that of the plug provided on the housing, which may be attached to the AC-adapter. However, the pin configuration adapter of the related art is attached the AC-adapter by simply inserting the pins of the AC-adapter to the pin configuration adapter and therefore an attachment force to the AC-adapter is weak. Therefore, there is a problem that the pin configuration adapter may fall off from the AC-adapter upon insertion to the power socket.

### SUMMARY OF THE INVENTION

Accordingly, it is a general object of the present invention to provide an AC-adapter and a pin configuration adapter for an AC-adapter which can solve the above problems.

It is another and more specific object of the present invention to provide a pin configuration adapter which can be attached to an AC-adapter in a secure manner.

In order to achieve the above objects, a combination is provided which includes:

an AC-adapter including:

a plug body having first pins of a first configuration; and

an AC-adapter housing having a conversion circuit for converting an electric power supplied via the plug body; and

a pin configuration adapter including:

a plug part having second pins of a having configuration different from the first pin configuration;

a receptacle part whereto the first pins can be inserted; and

a pin configuration adapter housing having an internal connection mechanism for electrically connecting the plug body and the plug part,

wherein the AC-adapter is provided with engagement grooves which engage with protrusions provided on the pin configuration adapter.

With the combination described above, the AC-adapter is prevented from being detached from the pin-configuration adapter when retracting the combination from the power socket. Each of the engagement groove may include a first engagement groove part and a second engagement groove part substantially perpendicular to said first engagement groove part, one of said first and second engagement groove parts extending in a direction perpendicular to a direction of insertion of said first pins into said pin configuration adapter.

### BRIEF DESCRIPTION OF THE DRAWINGS

FIG. 1 is a perspective view showing how a pin configuration adapter is attached to an AC-adapter in accordance with a first embodiment of the present invention.

FIG. 2 is a perspective view of the AC adapter of the first embodiment of the present invention.

FIGS. 3A through 3C are a plan view, a side view and a rear view, respectively, of the AC-adapter of the first embodiment of the present invention shown in a state where a parallel-blade pins are in an accommodated position.

FIGS. 4A through 4C are a plan view, a side view and a rear view, respectively, of the AC-adapter of the first embodiment of the present invention shown in a state where a parallel-blade pins are in an extruded position.

FIGS. 5A through 5C are a perspective view, a bottom view and a front view, respectively, of the pin configuration adapter of the first embodiment of the present embodiment.

FIGS. 6A and 6B are diagrams showing how the pin configuration adapter is attached to the AC-adapter in accordance with the first embodiment of the present invention.

FIG. 7 is a schematic view showing an internal structure of the pin configuration adapter of the first embodiment of the present invention.

FIG. 8 is a perspective view showing how a pin configuration adapter is attached to an AC-adapter in accordance with a second embodiment of the present invention.

FIGS. 9A through 9C are a plan view, a side view and a rear view, respectively, of the AC-adapter of the second embodiment of the present invention shown in a state where a parallel-blade pins are in an accommodated position.

FIG. 9D is a rear view of the AC-adapter of the second embodiment of the present invention shown in a state where a parallel-blade pins are in an extruded position.

FIGS. 10A through 10D are a perspective view, a plan view, a front view and a side view of a plug configuration adapter of the second embodiment of the present invention.

FIG. 11 is a schematic view showing an internal structure of the pin configuration adapter of the second embodiment of the present invention.

### DETAILED DESCRIPTION OF THE PREFERRED EMBODIMENTS

In the following, principles and embodiments of the present invention will be described with reference to the accompanying drawings.

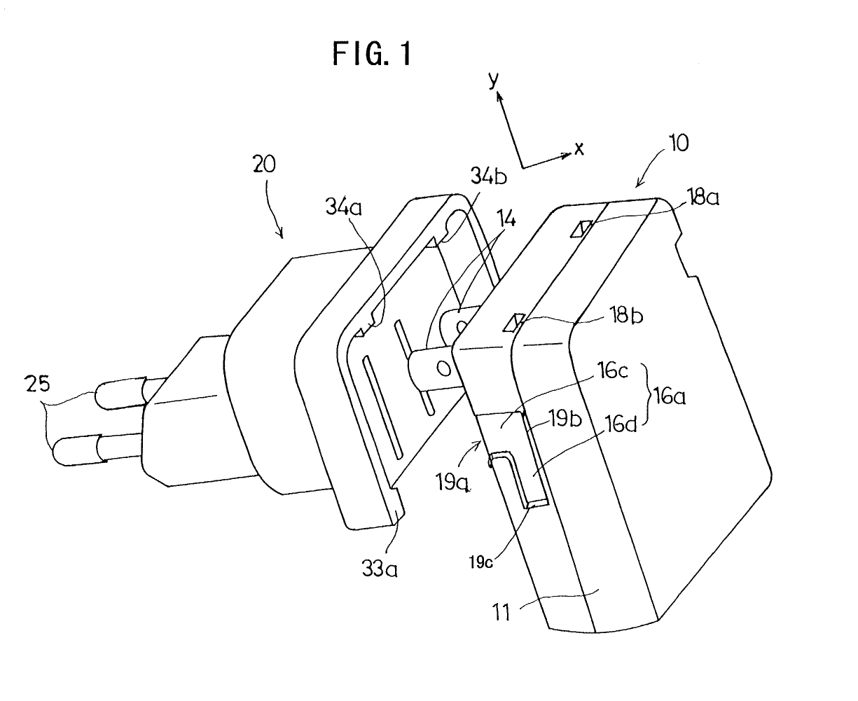

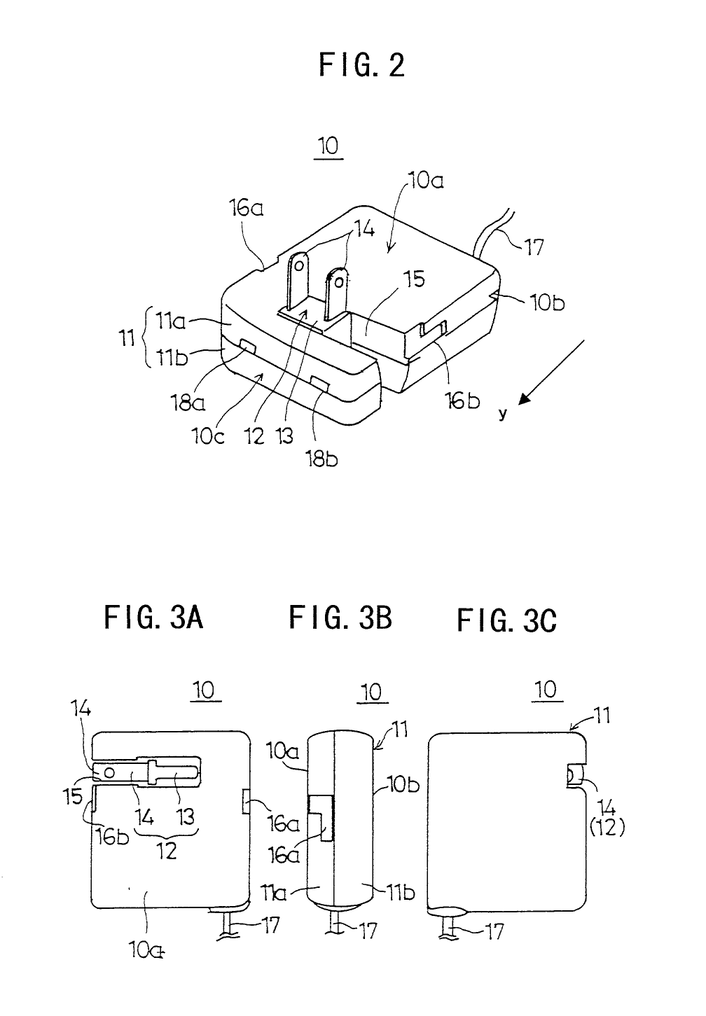

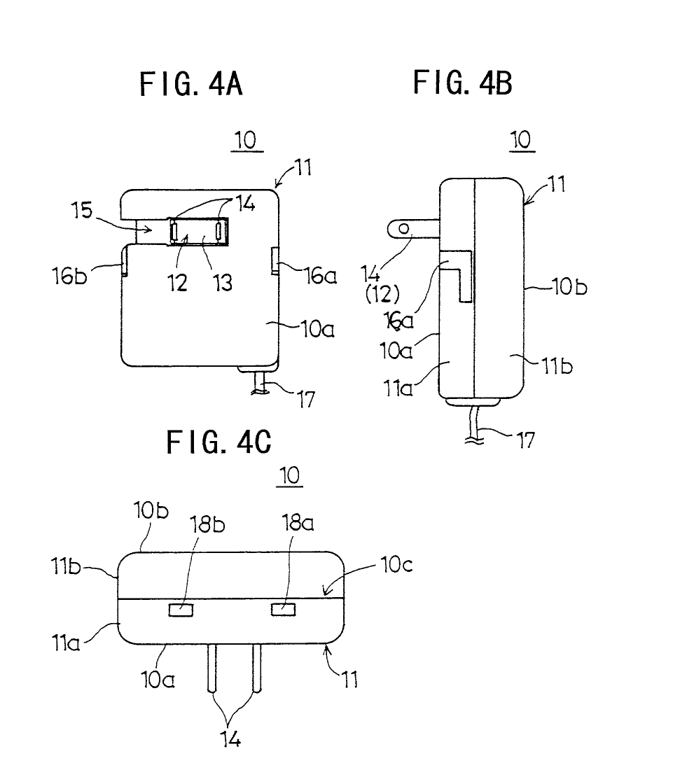

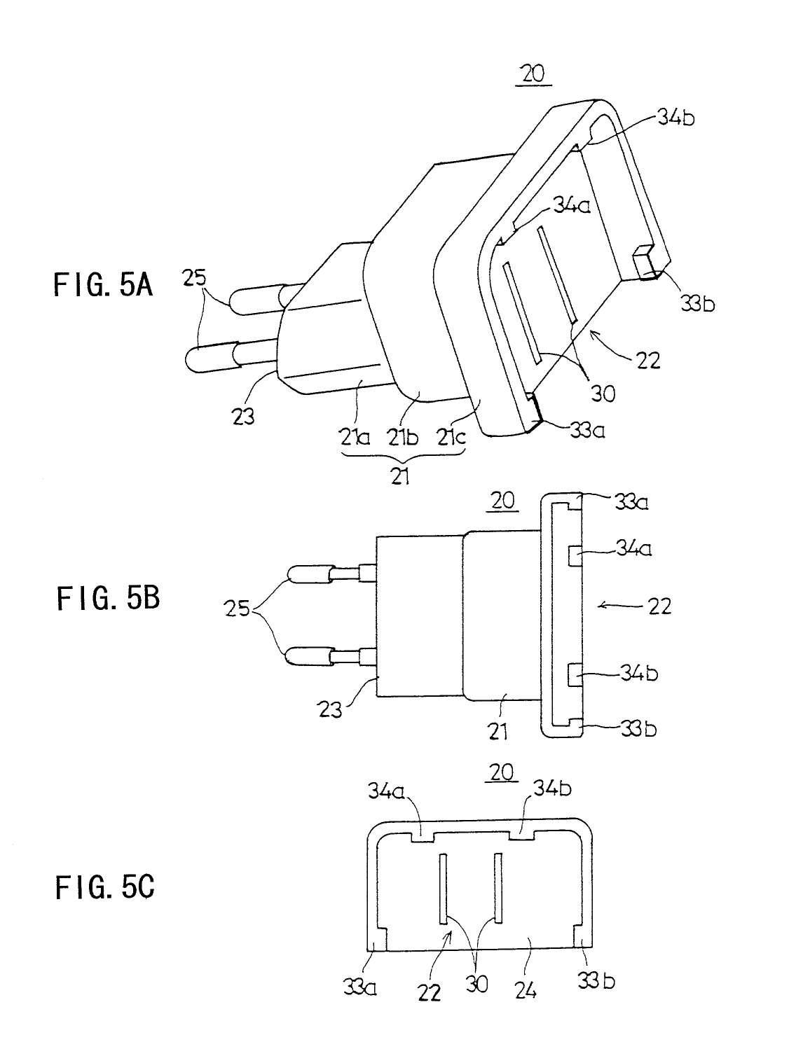

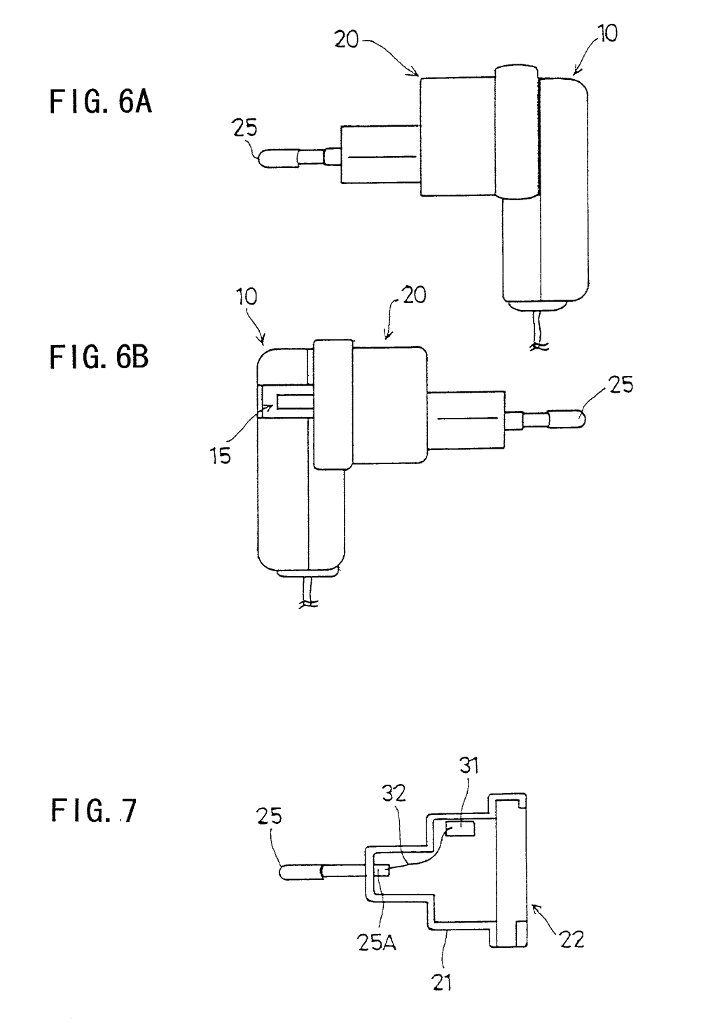

FIGS. 1 to 7 are diagrams used for explaining a pin configuration adapter for an AC-adapter (hereinafter referred to as a pin configuration adapter) 20 of a first embodiment the present invention. FIG. 1 is a diagram showing how the pin configuration adapter 20 is attached to an AC-adapter 10. FIG. 2 is a perspective view of the AC adapter 10. FIGS. 3A through 4C are diagrams showing the configuration of the AC-adapter 10. FIGS. 5A through 5C are diagrams showing the structure of the pin-configuration adapter 20. FIGS. 6A and 6B are diagrams showing how the pin-configuration adapter 20 is attached to the AC-adapter 10.

As shown in FIG. 1, in use, the pin configuration adapter 20 is attached to the AC-adapter 10.

Before describing the pin configuration adapter 20 in detail, an explanation will be made of the AC-adapter 10. As shown in FIG. 2, the AC-adapter 10 generally includes an AC-adapter housing 11, a rotatable plug body 12 and a cord 17.

The adapter housing 11 is a housing made of resin and includes a first housing half-body 11a and a second housing half-body 11b. The housing half-bodies 11a and 11b are fixed together to form the AC-adapter housing 11.

Inside the AC-adapter housing 11, there is provided a power transformer circuit (not shown) for converting an alternating current supplied from the rotatable plug body 12 to a direct current of a predetermined voltage.

Also, a recess 15 is formed at a predetermined position of the AC-adapter housing 11. The rotatable plug body 12 described below is provided in this recess 15.

Further, the AC-adapter housing 11 is provided with L-shaped engagement grooves 16a and 16b. The L-shaped engagement grooves 16a and 16b are provided on the side walls 10b of the AC-adapter housing 11.

As shown in FIG. 1, the L-shaped engagement grooves 16a, 16b (16b is not shown in the figure) includes a first engagement groove part 16c and a second engagement groove part 16d, which is substantially perpendicular to the first engagement groove part 16c. The second engagement groove part 16d is formed so as to extend substantially perpendicular to a direction of protrusion of parallel-blade pins 14. Also, the second engagement groove part 16d is formed such that it also extends substantially perpendicular to a direction of axis of round pins 25 of the pin-configuration adapter 20.

The L-shaped engagement grooves 16a and 16b are formed at positions corresponding to side-protrusions 33a and 33b. formed on the pinconfiguration adapter 20. The side-protrusions 33a and 33b. are provided to engage with the L-shaped engagement grooves 16a and 16b.

The AC-adapter housing 11 is provided with recessed parts 18a and 18b. The recessed parts 18a and 18b are provided on an upper surface 10C of the AC-adapter housing 11. The recessed parts 18a and 18b are formed at positions corresponding to upper-protrusions 34a and 34b formed on the pin-configuration adapter 20, which will be described later.

The rotatable plug body 12 includes a base part 13 and parallel-blade pins 14. The base part 13 is made of insulating resin and can be rotated about a rotational axis in a y-direction through an angle of approximately 90°. The parallel-blade pins 14 are formed in an integrated manner with the base part 13, for example, by insert molding. Accordingly, when the rotatable plug body 12 rotates about the rotational axis, the parallel-blade pins 14 also rotate about the rotational axis in an integrated manner.

In detail, the rotatable plug body 12 rotates through an angle of approximately 90° between a first position shown in FIGS. 2 through 4C, in which the parallel-blade pins 14 are accommodated in the recess 15, and a second position in which the parallel-blade pins 14 are substantially perpendicular to the upper surface 10a of the AC-adapter housing 11

Further, for safety reasons, the AC-adapter 10 of the present embodiment is configured as follows. When the rotational plug body 12 takes the first position, the parallel-blade pins 14 and the power supply converting circuit are disconnected. When the rotational plug body 12 takes the second position, that is to say only when using the AC-adapter 10, the parallel-blade pins 14 and the power supply conversion circuit are connected.

Now, the configuration of the pin configuration adapter 20 will be described with reference to FIGS. 5A through 5C.

The pin configuration adapter 20 generally includes a pin configuration adapter housing 21 and round pins 25.

The pin configuration adapter housing 21 is formed of a first housing part 21a, a second housing part 21b and a third housing part 21c. The housing parts 21a through 21c are made by resin molding and in the present embodiment, formed in an integrated manner by molding.

As shown in FIGS. 5A through 5C, the pin configuration adapter housing 21 is provided with a pair of round pins 25 protruding upwards from the upper surface 23. The round pins 25 conforms the European (EU) standard for plugs. Also, the third housing part 21c is provided with an AC-adapter attaching part 22 whereto the AC-adapter 10 is attached. The AC-adapter attaching part 22 is provided with plug-insertion holes 30. When the pin-configuration adapter 20 is attached to the AC-adapter, the parallel-blade pins 14 of the AC-adapter are inserted into the plug insertion holes 30.

The AC-adapter attaching part 22 is configured to fit with the AC-adapter 10. In detail, the AC-adapter attaching part 22 is provided with side-protrusions 33a, 33b which engage with engagement grooves 16a, 16b and upper-protrusions 34a, 34b which engage with recessed parts 18a, 18b. The side-protrusions 33a, 33b. and the upper-protrusions 34a, 34b constitute a pin-configuration adapter engagement structure.

As shown in FIGS. 5A through 5C, the side-protrusions 33a and 33b are formed on either sides of the front-end part of an inner surface of the AC-adapter attaching part 22. The side-protrusions 33a and 33b are formed integral with the pin-configuration adapter housing 21.

Also, the side-protrusions 33a and 33b are formed at positions corresponding to positions of open parts 19 of the L-shaped engagement grooves 16a and 16b formed on the AC-adapter 10.

The upper-protrusions 34a and 34b are formed on an inner upper surface of the AC-adapter attaching part 22 in an integrated manner with the pin configuration adapter housing 21. The upper-protrusions 34a and 34b are provided at positions corresponding to the recessed parts 18a and 18b formed on the AC adapter 10.

As shown in FIG. 1, the L-shaped engagement grooves 16a and 16b (16b is not shown in the figure) are formed such that the engagement groove parts 16d extend in a direction substantially perpendicular to the direction of an axis of the of round pins 25. With such a configuration, the side-protrusions 33a and 33b for engagement grooves are prevented from slipping out from the L-shaped engagement grooves 16a and 16b.

The above-described plug insertion holes 30 are configured such that the side-protrusions 33a and 33b provided on the pin-configuration adapter 20 can move along the L-shaped engagement grooves 16a and 16b of the AC-adapter 10 when attaching the AC-adapter 10 to the pin-configuration adapter 20.

In the present embodiment, as shown in FIGS. 5A to 5C, two recessed parts are formed on the inner upper surface of the AC-adapter attaching part 22. However, the number of protrusion is not limited to two, but any number of protrusions may be provided on the inner upper surface of the AC-adapter.

Referring now to FIG. 7, an internal structure of the pin configuration adapter housing 21 will be described.

FIG. 7 is a schematic diagram showing the pin configuration adapter housing 21. As shown in FIG. 7, the round pins 25 are fixed on the pin configuration adapter housing 21 for example by insert molding. The round pins 25 are configured such that connection parts 25A are provided at ends of the round pins 25 in the pin configuration adapter housing 21.

Contacts 31 are provided inside the pin configuration adapter housing 21 on an inner upper surface at positions opposing the pin insertion holes 30. The connection parts 25 formed on the round pins 25 and connection parts 31A formed on the contacts 31 are electrically connected by connection wires 32. Thus, an electrical connection is established between the round pins 25 and the contacts 31.

Thus, when the pin configuration adapter 20 is attached to the AC adapter 10 and the parallel-blade pins 14 engage with the contacts 31 via the pin insertion holes 30, the parallel-blade pins 14 will be electrically connected with the round pins 25 via the connection wires 32.

Now, an operation of attaching the above-described pin configuration adapter 20 to the AC-adapter 10 will be described.

In order to attach the pin configuration adapter 20 to the AC-adapter 10, as shown in FIG. 1, the side-protrusions 33a, 33b (33b is not shown in the figure) of the pin-configuration adapter 20 is positioned against the open parts 19 of the engagement grooves 16a and 16b of the AC-adapter 10. Then the pin configuration adapter 20 is moved along the x-axis until the side-protrusions 33a and 33b of the pin configuration adapter 20 touches wall parts 19b of the L-shaped engagement grooves 16a and 16b. Then, the AC-adapter 10 is moved along the y-axis until the side-protrusions 33a and 33b of the pin configuration adapter 20 reaches end parts 19c of the L-shaped engagement grooves 16a and 16b of the AC-adapter 10. Thus, the upper protrusion 34a and 34b of the pin configuration adapter 20 engage with engagement grooves 18a and 18b of the AC-adapter 10. Accordingly, the pin configuration adapter 20 and the AC-adapter 10 are attached.

In such a manner, the side-protrusions 33a and 33b of the pin configuration adapter 20 are guided to end parts of the L-shaped engagement grooves 16a and 16b of the AC-adapter 10. Thus, the pin configuration adapter 20 can be easily attached to the AC-adapter 10. It is to be noted that a direction in which the side-protrusions 33a, 33b of the pin configuration adapter 20 moves along the engagement grooves 16a, 16b of the AC-adapter 10 and a direction in which a force is applied while insertion and retraction from the power socket are perpendicular. Therefore, even if the pin configuration adapter 20 is inserted into and pulled out of the power supply outlet with the AC-adapter 10 being attached thereto, the pin configuration adapter 20 is prevented from being detached from the AC-adapter 10. Accordingly, the pin configuration adapter 20 and the AC-adapter 10 can be attached in a secure manner.

Also, since the upper protrusions 34a and 34b of the pin configuration adapter 20 engage with the recessed parts 18a and 18b of the AC-adapter 10, the pin configuration adapter 20 is further prevented from being detached from the AC-adapter 10. Accordingly, the pin configuration adapter 20 and the AC-adapter 10 can be attached in a more secure manner.

With such an attaching operation, the parallel-blade pins 14 of the AC-adapter 10 and the plug insertions holes 30 formed in the AC-adapter attaching part 22 of the conversion plug 20 can be engaged accurately.

With the pin configuration adapter 20 being attached to the AC-adapter 10, the parallel-blade pins 14 are inserted into the pin-configuration adapter housing 21 of the pin configuration adapter 20 via the plug insertion holes 30.

In this manner, the parallel-blade pins 14 engage with and are electrically connected to the contacts 31 and further electrically connected to the round pins 25 via the connection wire 32. Therefore, with the pin configuration adapter 20 being attached, the AC-adapter 10 can be used in those countries adopting the round pins 25 as the standard for pin configuration.

In the following, a second embodiment of the present invention will be described.

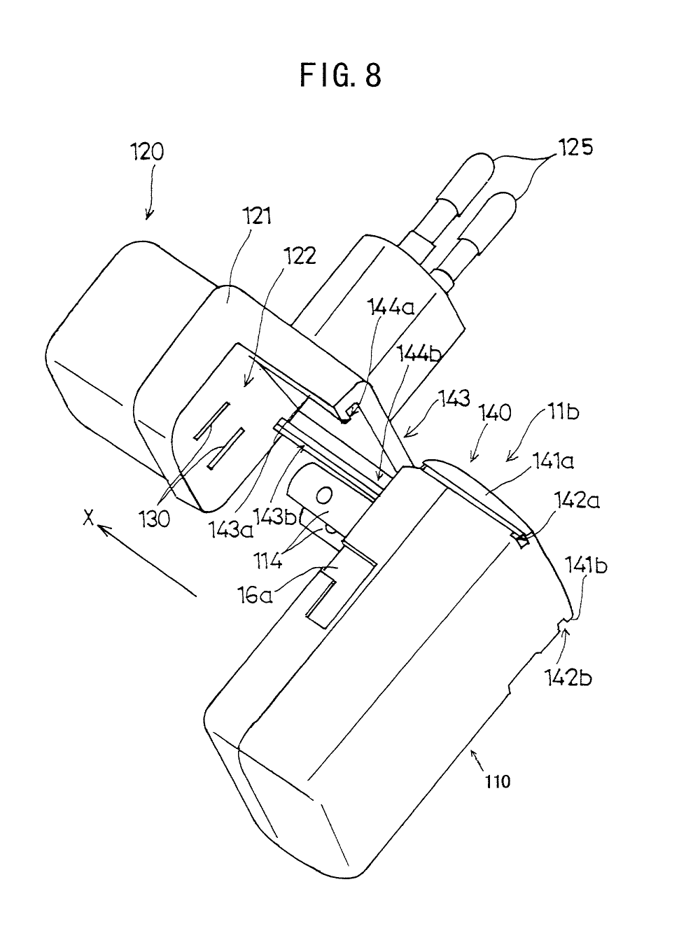

FIGS. 8 through 11 are diagrams used for explaining the second embodiment of the present invention.

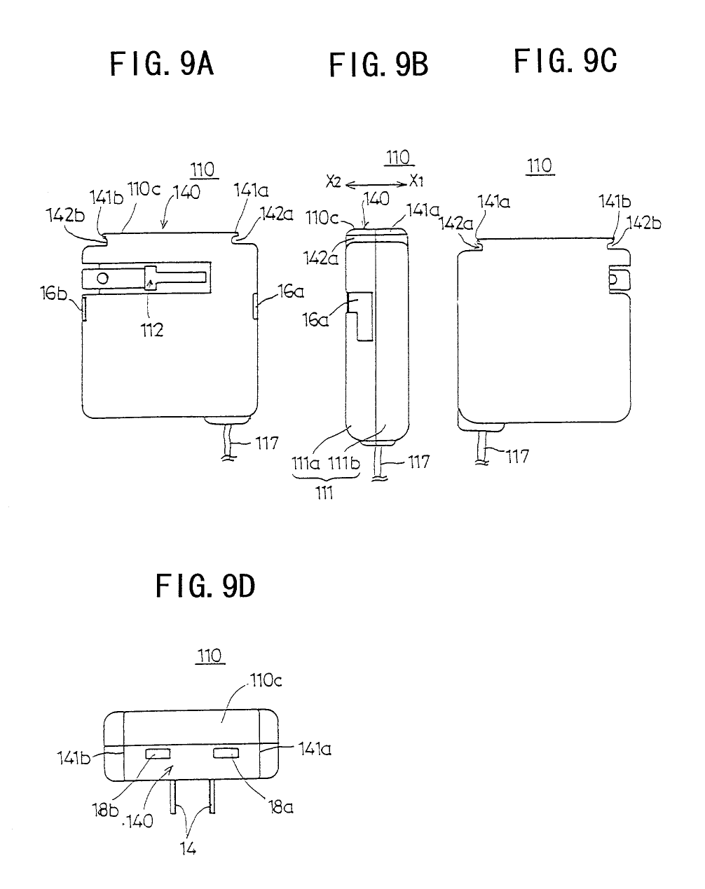

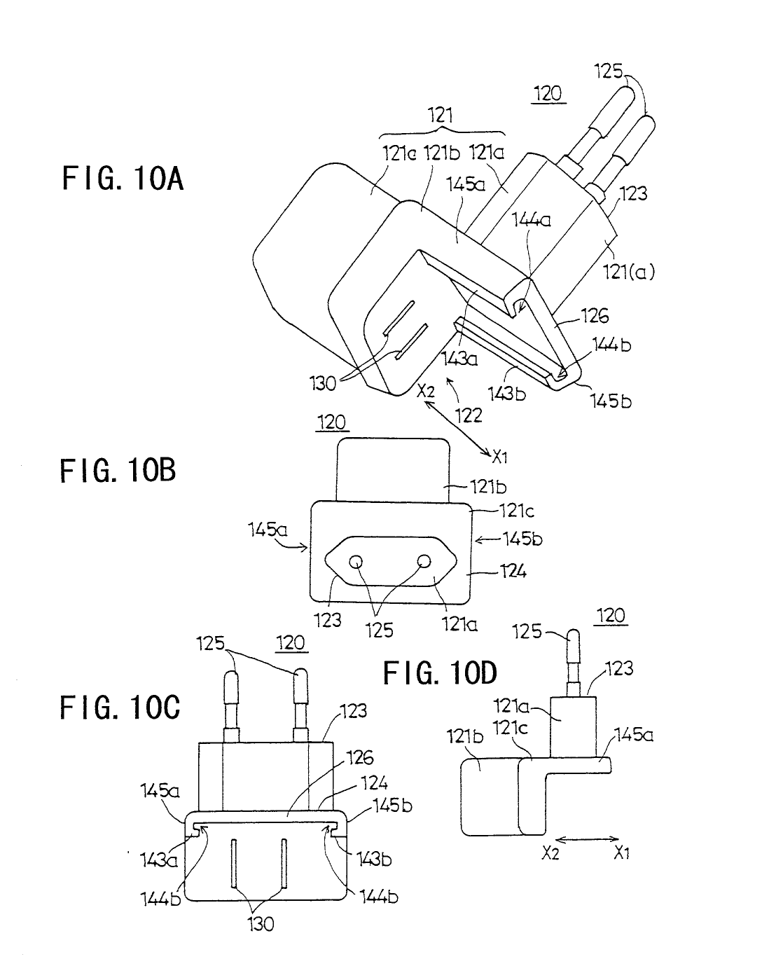

FIG. 8 is a perspective view showing how a pin configuration adapter 120 is attached to an AC-adapter 110 in accordance with a second embodiment of the present invention. FIGS. 9A through 9C are diagrams showing a structure of the AC-adapter 110 of the second embodiment of the present invention. FIGS. 10A through 10D are diagrams showing a plug configuration adapter 120 of the second embodiment of the present invention.

As shown in FIG. 8, when in use, the pin configuration adapter 120 is attached to the AC-adapter. This is similar to the case of the first embodiment.

Before explaining the pin configuration adapter 120, the structure of the AC-adapter 110 will be described. Elements similar to those of the first embodiment are labeled using the same reference numerals and will not be explained in a further detail.

As shown in FIGS. 8 through 9D, the AC-adapter 110 generally includes an AC-adapter housing 111, a rotatable plug body 112 and a cord 117. The adapter housing 111 includes a first housing half-body 111a and a second housing half-body 111b.

Inside the AC-adapter housing 111, there is provided a power transformer circuit (not shown) for converting an alternating current supplied from the rotatable plug body 12 to a direct current of a predetermined voltage.

On an upper surface 110c of the AC-adapter housing 111, collar parts 141a, 141b are formed along the X1- and X2-directions. The collar parts 141a and 141b protrude outwardly. Also, with such collar parts 141a and 141b being provided, grooves 142a and 142b are formed on upper side edges of the AC-adapter housing 111.

The grooves 142a and 142b extend along entire length of the side edges of the AC-adapter housing 111 (X1- and X2-direction in the Figure).

In the present embodiment, the grooves 142a and 142b are configured to extend along entire length of the side edges of the AC-adapter housing 111. However, the length of the grooves 142a and 142b may be shorter than the entire length of the side edges of the AC-adapter housing 111. Also, as shown in FIG. 9, in the present embodiment, the grooves 142a and 142b are provided on the upper side surface of the AC-adapter housing 111. However, the grooves 142a and 142b may be provided at any position as long as they are on the side surface of the AC-adapter housing 111.

As shown in FIG. 8, the grooves 142a and 142b extend substantially parallel to the direction in which the parallel-blade pins 114 of the AC-adapter 110 extend. The grooves 142a and 142b extend in a direction substantially perpendicular to the direction of axis of the round pins 125 of the pin configuration adapter 120.

The collar parts 141a, 141b and the grooves 142a, 142b formed on the AC-adapter housing 111 constitute an engagement structure 140.

The AC-adapter engagement structure 140 is configured to correspond to an engagement structure of the pin configuration adapter 120 described later.

The AC-adapter housing 111 is provided with L-shape engagement grooves 16a and 16b as has been described in relation to the first embodiment. The L-shaped engagement grooves 16a and 16b are formed on side surfaces of the AC-adapter housing 111. Also, as shown in FIG. 9D, the recessed parts 18a and 18b described in the first embodiment are formed on an upper surface 110c of the AC-adapter housing 111. If the L-shaped engagement grooves 16a, 16b and the recessed parts 18a, 18b are formed on the AC-adapter housing 111, this AC-adapter 110 can also be used for the pin configuration adapter 20 described in the first embodiment.

In the following, the structure of the pin configuration adapter 120 will be described with reference to FIG. 10.

The pin configuration adapter 120 generally includes a pin configuration adapter housing 121, round pins 125 and an AC-adapter attaching part 122.

As shown in FIG. 10, the pin configuration adapter housing 121 is formed of a first housing part 121a, a second housing part 121b and a third housing part 121c. The housing parts 121a through 21c are made by resin molding and in the present embodiment, formed in an integrated manner by molding.

The pin configuration adapter housing 121 is provided with a pair of round pins 125 protruding upwards from the upper surface 123 of the first housing part 121a.

The AC-adapter attaching part 122 is provided with plug-insertion holes 130. When the pin-configuration adapter 120 is attached to the AC-adapter 110, the parallel-blade pins 114 of the AC-adapter 110 are inserted into the plug insertion holes 130. In the second embodiment, the plug insertion holes 130 may be formed with a length sufficient for receiving the parallel-blade pins 114. This differs from the first embodiment of the present invention.

On an upper surface 124 of the third housing part 121c, a supporting part 126 for supporting the first housing part 121a is formed.

Wall parts 145a and 145b are formed on either sides of the supporting part 126 along the X1-, X2-directions in FIGS. 10A and 10D. The wall parts 145a and 145b constitute a side surface of the adapter attaching part.

Also, the wall parts 145a and 145b are provided with engagement collars 143a and 143b. which protrude inwardly. The engagement collars 143a and 143b. also extend along the X1-, X2-directions in FIGS. 10A and 10D in a similar manner to the walls 145a and 145b.

The engagement collars 143a and 143b. are configured to correspond to the shape of the grooves 142a and 142b of the AC-adapter 110 and extend in a direction substantially perpendicular to the direction of axis of the round pins 125.

As shown in FIG. 8, guide grooves 144a and 144b are formed so as to mate with the engagement collar 143a, respectively. The engagement collars 143a, 143b and the guide grooves 144a, 144b formed on the wall parts 145a, 145b constitute the pin-configuration adapter engagement structure 143. The pin-configuration adapter engagement structure 143 is configured to mate with the above-described AC-adapter engagement structure 140.

Also, in the present embodiment, as shown in FIG. 8, the engagement collars 143a, 143b of the pin configuration adapter 120 are formed at positions corresponding to the engagement grooves 142a, 142b of the AC-adapter housing 111. However, the engagement collars 143a and 143b may be provided at any position on the inner surface of the adapter attaching part 122 as long as they correspond to the engagement grooves 142a, 142b of the AC-adapter housing 111.

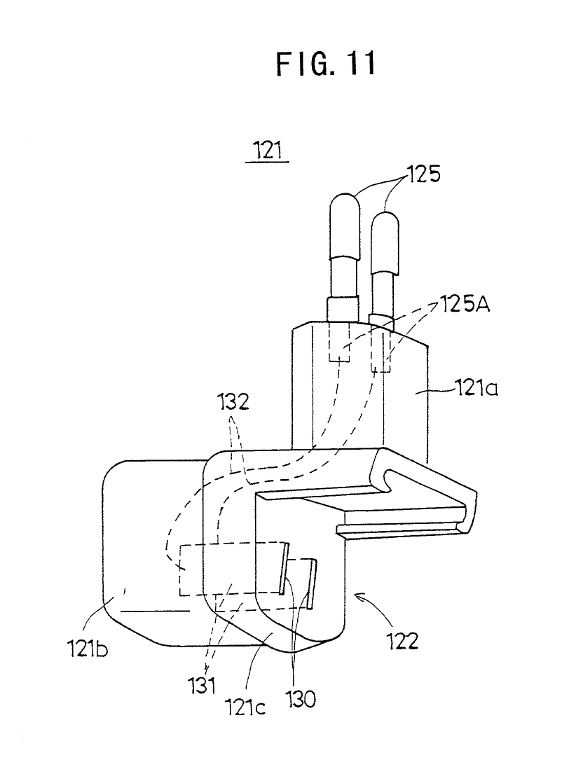

In the following, an internal structure of the pin-configuration adapter housing 121 will be described with reference to FIG. 11.

FIG. 11 is a schematic diagram showing an internal structure of the pin-configuration adapter housing 121. As shown in FIG. 11, the round pins 125 are fixed on the pin configuration adapter housing 121 for example by insert molding. The round pins 125 are configured such that connection parts 125A are provided at ends of the round pins 125 in a first pin configuration adapter housing 121a. Also, inside the second housing part 121b opposing the plug insertion holes 130 formed in the adapter attaching part 122 and the third housing part 121c, contacts 131 are provided as shown by dashed lines. The connection parts 125A formed on the round pins 125 and the contacts 131 are electrically connected by connection wires 132.

Thus, an electrical connection is established between the round pins 125 and the contacts 131. Thrs, when the pin configuration adapter 120 is attached to the AC adapter 110 and the parallel-blade pins 114 engage with the contacts 131 via the pin insertion holes 130, the parallel-blade pins 114 will be electrically connected with the round pins 125 via the connection wires 132.

Now, an operation of attaching the above-described pin configuration adapter 120 to the AC-adapter 110 will be described.

In order to attach the pin configuration adapter 120 to the AC-adapter 110, as shown in FIG. 8, the AC-adapter engaging structure 140 of the AC-adapter 10 and the pin-configuration adapter engaging structure 143 of the pin-configuration adapter 120 are positioned and the AC-adapter 110 is moved in the X-direction.

In detail, the engagement collars 143a, 143b of the pin configuration adapter 120 are inserted into the guide grooves 142a, 142b, respectively of the AC-adapter 110. Thus, the AC-adapter engagement structure 140 and the pin configuration adapter engagement structure 143 are engaged.

Accordingly, the pin configuration adapter 120 and the AC-adapter 110 are attached. The engagement collars 143a, 143b of the pin configuration adapter 120 are guided along the engagement grooves 142a, 142b of the AC-adapter 110. Thus, the pin configuration adapter 120 can be easily attached to the AC-adapter 110. It is to be noted that a direction in which the engagement collars 143a, 143b of the pin configuration adapter 20 detaches from the engagement grooves 142a, 142b of the AC-adapter 110 and a direction in which a force is applied while insertion and retraction from the power socket are perpendicular. Therefore, even if the pin configuration adapter 120 is inserted into and pulled out of the power supply outlet with the AC-adapter 110 being attached thereto, the pin configuration adapter 120 is prevented from being detached from the AC-adapter 110. Accordingly, the pin configuration adapter 120 and the AC-adapter 110 can be attached in a secure manner.

With such an attaching operation, the parallel-blade pins 114 of the AC-adapter 110 and the plug insertions holes 130 formed in the AC-adapter attaching part 122 can be engaged accurately.

With the pin configuration adapter 120 being attached to the AC-adapter 110, the parallel-blade pins 114 are inserted into the pin-configuration adapter housing 121 of the pin configuration adapter 120 via the plug insertion holes 130.

In this manner, the parallel-blade pins 114 engage with and are electrically connected to the contacts 131 and further electrically connected to the round pins 125 via the connection wire 132.

Also, if the L-shaped engagement grooves 16a, 16B and the recessed parts 18a, 18b are further provided on the AC-adapter housing 111, this AC-adapter 110 can be used for the pin configuration plug 20 described in the first embodiment.

Therefore, with the pin configuration adapter 120 being attached, the AC-adapter 110 can be used in those countries adopting the round pins 125 as the standard for pin configuration.

It is to be noted that the above embodiment has been described using the round pins 25 and 125 as an example of the pins provided on the pin configuration adapter 20 and 120. However, the pin configuration adapter 20 and 120 may be altered to configurations conforming the standards for various countries by providing pins of various types on the pin configuration adapter housing 21 and 121. For example, the pins of the pin configuration adapter can be configured as non-parallel blade pins and 3-terminal pins.

The present invention has been described with reference to preferred embodiments. However, the present invention is not limited to these embodiments, and variations and modifications may be made without departing from the scope of the present invention.

The present application is based on Japanese priority application No. 2001-59274 filed on Mar. 2, 2001, the entire contents of which are hereby incorporated by reference.

What is claimed is:

1. A combination comprising:
an AC-adapter including:
a plug body having first pins of a first configuration; and
an AC-adapter housing having a conversion circuit for converting an electric power supplied via said plug body; and
a pin configuration adapter including:
a plug part having second pins of a having configuration different from said first pin configuration;
a receptacle part whereto said first pins can be inserted; and
a pin configuration adapter housing having an internal connection mechanism for electrically connecting said plug body and said plug part,
wherein said AC-adapter is provided with engagement grooves which engage with protrusions provided on said pin configuration adapter.

2. The combination as claimed in claim 1, wherein said engagement grooves extend in a direction parallel to a direction of insertion of said first pins into said pin configuration adapter.

3. The combination as claimed in claim 1, wherein each of said engagement groove includes a first engagement groove part and a second engagement groove part substantially perpendicular to said first engagement groove part, one of said first and second engagement groove parts extending in a direction perpendicular to a direction of insertion of said first pins into said pin configuration adapter.

4. The combination as claimed in claim 1, wherein said AC-adapter is provided with at least one recessed part on an upper surface of said AC-adapter housing and said pin configuration adapter is provided with at least one further protrusion which engage with said recessed part.

5. The combination as claimed in claim 1, wherein said plug body is rotatable between a first position in which said plug body is accommodated in a recess formed in said AC-adapter housing and a second position in which said plug body is in an upright position with respect to said AC-adapter housing.

6. The combination as claimed in claim 1, wherein said pin configuration adapter further comprises:
an AC-adapter attaching part provided on said plug configuration adapter housing and whereto said AC-adapter can be attached, said protrusions being formed on an inner surface of said AC-adapter attaching part.

7. The combination as claimed in claim 1, further comprising engagement collar parts provided on upper edges of said AC-adapter housing and guide grooves provided on upper edges of the side surfaces of said AC-adapter attaching part.

8. An AC-adapter having a plug body having first pins of a first configuration; and an AC-adapter housing having a conversion circuit for converting an electric power supplied via said plug body, said AC-adapter capable of being attached to a pin configuration adapter having a plug part having second pins of a second configuration different from said first pin configuration,
wherein said AC-adapter is provided with engagement grooves which engage with protrusions provided on said pin configuration adapter.

9. A pin configuration adapter capable of being attached to an AC-adapter having a plug body having first pins of a first configuration and an AC-adapter housing having a conversion circuit for converting an electric power supplied via said plug body, said pin configuration adapter comprising:
a plug part having second pins of a second configuration different from said first pin configuration;
a receptacle part whereto said plug body in said second position can be inserted; and
a pin configuration adapter housing having an internal connection mechanism for electrically connecting said plug body and said plug part,
wherein said pin configuration adapter is provided with protrusions which engage with engagement grooves provided on said AC-adapter.
